(19) United States
(12) Patent Application Publication
(10) Pub. No.: US 2013/0051263 A1
(43) Pub. Date: Feb. 28, 2013

(54) MOBILE TERMINAL, MOBILE COMMUNICATION CONTROL METHOD, AND MOBILE COMMUNICATION SYSTEM

(71) Applicant: Masahiro Watanabe, Tachikawa (JP)

(72) Inventor: Masahiro Watanabe, Tachikawa (JP)

(73) Assignee: FUJITSU LIMITED, Kawasaki-shi (JP)

(21) Appl. No.: 13/589,348

(22) Filed: Aug. 20, 2012

(30) Foreign Application Priority Data
Aug. 29, 2011 (JP) 2011-186234

(51) Int. Cl. H04W 24/00; H04W 36/08

(52) U.S. Cl. 370/252

(57) ABSTRACT

A mobile terminal includes a first transceiver which communicates a first signal in a first frequency band, a second transceiver which communicates a second signal in a second frequency band, a measuring section which measures a reception quality of the first signal, and a reception quality of the second signal, a storage which stores one or more index values based on the reception quality of the first signal which is obtained when the reception quality of the second signal becomes less than or equal to a threshold value, and a controller which puts the second transceiver into a sleep mode when the reception quality of the second signal becomes less than or equal to a threshold value, and cancels the sleep mode when a subsequently measured reception quality of a first signal becomes equal to or greater than the one or more index values.

### CROSS-REFERENCE TO RELATED APPLICATION

This application is based upon and claims the benefit of priority of the prior Japanese Patent Application No. 2011-186234, filed on Aug. 29, 2011, the entire contents of which is incorporated herein by reference.

### FIELD

Embodiments discussed herein are related to a mobile terminal, a mobile communication control method, and a mobile communication system.

### BACKGROUND

In recent mobile communications, data communication applications have been expanding instead of voice communication that is the primary communication application in conventional mobile phones. Data communication applications include Internet access, streaming broadcasts, and the delivery of rich content such as music and video, for example. With data communication applications, fast transmission of large amounts of data is often demanded. For this reason, the adoption of wider bandwidth communication is being investigated. Among such investigations of wideband communication, a technique called carrier aggregation is being investigated, in which a single mobile terminal contemporaneously uses a plurality of frequency bands.

### SUMMARY

According to an aspect of the embodiments discussed herein, a mobile terminal includes a first transceiver which communicates a first signal in a first frequency band, a second transceiver which communicates a second signal in a second frequency band, a measuring section which measures a reception quality of the first signal received by the first transceiver, and a reception quality of the second signal received by the second transceiver, a storage which stores one or more index values based on the reception quality of the first signal which is obtained when the reception quality of the second signal becomes less than or equal to a threshold value, and a controller which puts the second transceiver into a sleep mode when the reception quality of the second signal becomes less than or equal to a threshold value, and cancels the sleep mode when a subsequently measured reception quality of a first signal becomes equal to or greater than the one or more index values.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating exemplary allocation of frequencies for a communication service that contemporaneously uses a plurality of frequency bands;

FIG. 2 is a diagram illustrating exemplary coverage areas for a communication service able to contemporaneously use a plurality of frequency bands;

FIG. 3 is a schematic diagram illustrating a basic configuration of a mobile station able to contemporaneously use a plurality of frequency bands;

FIG. 4 is a schematic diagram illustrating a working example of a mobile station;

FIG. 5 is a diagram for explaining a sleep control method of a first embodiment;

FIG. 6 is a diagram for explaining a sleep control method of a first embodiment;

FIGS. 7A and 7B are flowcharts of a sleep control process (exemplary process 1);

FIG. 8 is a flowchart of a sleep control process (exemplary process 2);

FIG. 9 is a diagram for explaining a sleep control method that uses announce information;

FIG. 10 is a diagram illustrating exemplary announce information announced by a serving base station;

FIG. 11 is a flowchart illustrating an exemplary process of a second embodiment;

FIG. 12 is a flowchart illustrating an exemplary process of a second embodiment;

FIG. 13 is a flowchart illustrating an exemplary process of a second embodiment; and

FIG. 14 illustrates an example of the handover process illustrated in FIG. 11.

### DESCRIPTION OF EMBODIMENTS

Hereinafter, the embodiments of the disclosed technology will be described with reference to the drawings. The configurations of the following embodiments are exemplary, and the disclosed technology is not limited thereto.

While inventing the present embodiments, observations were made regarding a related art. Such observations include the following, for example.

In a mobile communication system of a related art, rather than just supporting the above carrier aggregation, it is also conceivable for a mobile terminal capable of using a plurality of frequency bands to selectively use one among the plurality of frequency bands depending on the signal reception in each frequency band.

In this case, it is envisioned that a mobile terminal would be provided with a plurality of transceivers which respectively correspond to the plurality of frequency bands. The mobile terminal receives announce information from a base station in the coverage area of a particular frequency band (i.e., the area in which a signal can be received from a base station), and checks whether or not the corresponding frequency band is available.

At this point, it is not preferable to allow unrestricted operation of the mechanism that detects announce information corresponding to each of the plurality of frequency bands supported by the mobile terminal, as doing so may lead to increases in the power consumption of the mobile terminal. One technique for reducing power consumption is to equip a given mechanism included in the mobile terminal with a sleep function that temporarily restricts operation or stops power supply (i.e., enacts a low-power mode).

### 1. First Embodiment

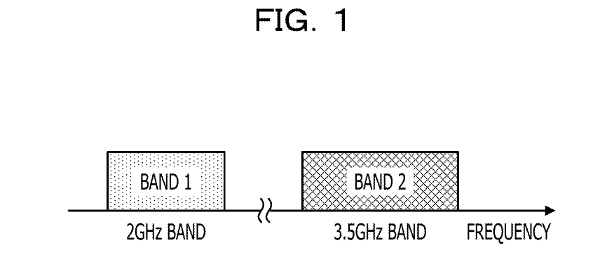

Hereinafter, a mobile terminal (hereinafter designated “mobile station”) in accordance with a first embodiment will be described with reference to FIGS. 1 to 8.

[1.1. Communication Service Area]

A mobile station in the first embodiment is able to contemporaneously use a plurality of frequency bands. FIG. 1 illustrates an example of a plurality of frequency bands contemporaneously usable by a mobile station. The plurality of frequency bands contemporaneously usable by a mobile station includes a Band 1 in the 2 GHz band (a first frequency band), and a Band 2 at a higher frequency than Band 1 in the 3.5 GHz band (a second frequency band).

In other words, the mobile station is able to conduct wideband communication (i.e., high-speed communication) by contemporaneously using both Band 1 and Band 2 (i.e., carrier aggregation). Carrier aggregation is a technology that increase bandwidth by plurally bundling frequency blocks (component carriers) having a given communication bandwidth. It is also possible for a mobile station to communicate by selectively using either Band 1 or Band 2. If Band 2 is used, it is possible to execute faster communication compared to Band 1.

By using Band 1, a mobile station is able to use an audio telephony service or a low-speed data communication service such as downloading still images, for example. By using Band 2, a mobile station is able to make full use of a video streaming service, for example. Furthermore, by contemporaneously using Band 1 and Band 2, a mobile station is able to make full use of wideband communication services.

Herein, an example of a mobile station that supports carrier aggregation is given in the first embodiment. However, the disclosed technology is not limited to a mobile station able to execute wideband communication that contemporaneously uses a plurality of frequency bands. In other words, it is sufficient for a mobile station to be able to use a plurality of frequency bands. Consequently, the mobile station may also be a mobile station able to separately but contemporaneously use a plurality of frequency bands. Alternatively, the mobile station may also be a mobile station able to selectively use one among a plurality of frequency bands.

Moreover, the above 2 GHz band and 3.5 GHz band are given by way of example, and other bands such as the 800 MHz band, 1.5 GHz band, and 1.7 GHz used by W-CDMA (Wideband Code Division Multiple Access), for example, are also applicable. A combination of plural frequency bands may also be set as appropriate. Additionally, a mobile station is not limited to supporting two frequency bands, and may also support three or more.

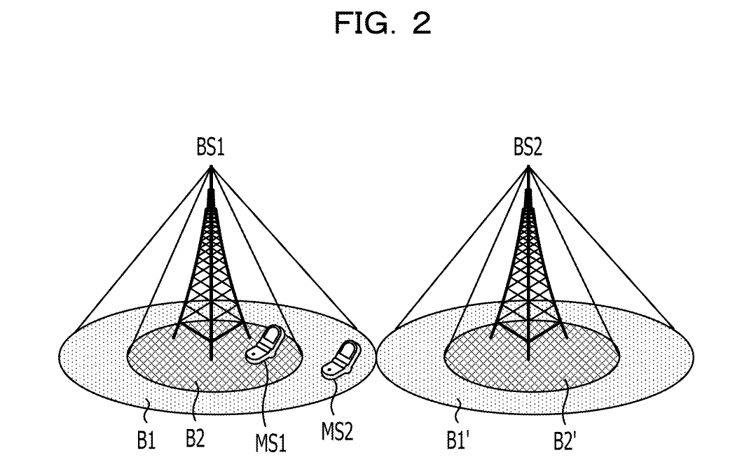

FIG. 2 illustrates exemplary coverage areas (service areas) of base stations BS1 and BS2 that support Band 1 and Band 2 illustrated in FIG. 1. The base station BS1 supports both Band 1 and Band 2, with a coverage area B1 in which a mobile station can make use of communication services using Band 1, and a coverage area B2 in which a mobile station can make use of communication services using Band 2. Since the differences between the frequency bands yield different signal propagation characteristics, the coverage areas differ in size even if formed using the same transmit signal power. In the example in FIG. 1, the Band 2 frequency band is relatively higher than the Band 1 frequency band, and thus the Band 2 coverage area B2 is smaller than the Band 1 coverage area B1.

In the example illustrated in FIG. 2, the respective coverage areas B1 and B2 for Band 1 and Band 2 are formed by the same base station BS1. Thus, the coverage areas B1 and B2 are formed in concentric circles centered on the position of the base station BS1. (Actual coverage areas are not strictly circular, but are schematically illustrated as such in FIG. 2.)

Consequently, the entire coverage area B2 overlaps with the coverage area B1, and a mobile station in the coverage area B2 is able to use both Band 1 and Band 2. The base station BS1 transmits announce information for Band 1 and Band 2 each, and the respective announce information is propagated throughout the corresponding coverage area. A mobile station conducts an announce information detection process (search process) at appropriate timings. A mobile station that has detected announce information is able to use the announce information to conduct a connection procedure (attach procedure) with respect to the base station, and start communicating via the base station.

Consequently, a mobile station in the coverage area B2 (illustrated by example as the mobile station MS1 in FIG. 2) is able to respectively receive (detect) announce information for Band 1 and announce information for Band 2 from the base station BS1. The mobile station MS1 uses the received announce information to connect to the base station BS1 on both Band 1 and Band 2, and is able to start communicating using at least one of Band 1 and Band 2. In other words, the mobile station MS1 is able to selectively communicate using Band 1 or Band 2, or alternatively, communicate by contemporaneously using Band 1 and Band 2. For example, a mobile station in the coverage area B2 is able to make full use of wideband high-speed data communication services by contemporaneously using Band 1 and Band 2.

In contrast, a mobile station in the coverage area B1 (illustrated by example as the mobile station MS2 in FIG. 2) may only be able detect announce information for Band 1 from the base station BS1. For this reason, the mobile station MS2 may only be able to communicate using Band 1. In this way, in the coverage area B2, a mobile station is able to conduct communication that is faster than the communication available in the coverage area B1, depending on the type of communication service to be used.

Similarly to the base station BS1, a base station BS2 supports both Band 1 and Band 2, with a Band 1 coverage area B1′ and a Band 2 coverage area B2′ formed overlapping each other and concentric about the base station BS2. The coverage areas B1′ and B2′ are nearly equal in size to the coverage areas B1 and B2. The coverage area B1 and the coverage area B1′ are positioned adjacent to each other.

At the boundary portion between the coverage area B1 and the coverage area B1′ (in FIG. 2, the portion where the coverage area B1 and the coverage area B1′ are in contact), a mobile station is able to receive Band 1 announce information from both base stations BS1 and BS2. A mobile station conducts a handover for a given frequency band (Band 1, in the example in FIG. 2) when the receive signal level of announce information (i.e., a radio wave) from an adjacent base station (i.e., a target base station, such as the base station BS2) becomes greater than the receive signal level of announce information from the currently connected base station (i.e., the serving base station, such as the base station BS1) and when a given threshold value is exceeded. With a handover, a mobile station is able to continue communicating using Band 1.

In contrast, in the example in FIG. 2, the Band 2 coverage areas B2 and B2′ are separated from each other. For this reason, a mobile station in the coverage area B2 may not receive Band 2 announce information from the other base station BS2. Likewise, a mobile station in the coverage area B2′ may not receive Band 2 announce information from the other base station BS1. Consequently, a mobile station may be unable to conduct a handover between the base station BS1 and the base station BS2 for Band 2. Consequently, a mobile station may be unable to continue communicating using Band 2 if the mobile station becomes separated from the Band 2 coverage areas B2 and B2′. Communication using Band 2 resumes in the case where the mobile station re-enters the Band 2 coverage area B2 or B2′.

For example, in FIG. 2, if a mobile station moves from the position of the mobile station MS1 to the position of the mobile station MS2 while communicating using Band 2, the mobile station may be disconnected from communication using Band 2. In this case, the mobile station is able to resume communicating using Band 2 by re-entering the coverage area B2 or B2′.

In a mobile station according to the first embodiment, a sleep function is included for each mechanism that transmits or receives Band 1 or Band 2 signals. The sleep function curtails power consumption of a corresponding mechanism by suspending operation of the corresponding mechanism or terminating power supply in the case where there is a high probability the mobile station will not or is unable to use Band 1 or Band 2.

For example, the sleep function may be invoked for mechanisms corresponding to Band 2 under conditions where the mobile station is able to use Band 1 but may be unable to use Band 2. As a result, operation is suspended or power supply is terminated for mechanisms corresponding to Band 2. Typically, a mobile station periodically searches for Band 2 announce information from a base station (i.e., conducts a search process) in an environment where Band 2 is unavailable. However, a search process wastes power in an environment where it may not be possible to receive Band 2 announce information. By invoking the above sleep function, execution of a Band 2 search process is terminated, thereby reducing wasted power in the mobile station.

However, putting a Band 2 search process into a sleep mode means that a search process for receiving Band 2 announce information announced in a Band 2 coverage area may not be executed, even when a mobile station is inside that coverage area. For this reason, a mobile station according to the first embodiment applies control to cancel Band 2 sleep mode on the basis of the reception quality of Band 1 announce information.

[1.2. Mobile Station Configuration]

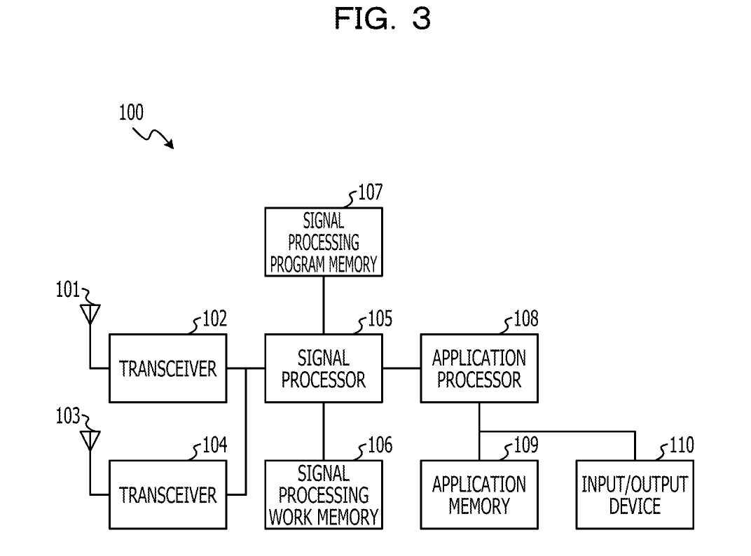

FIG. 3 illustrates an exemplary hardware configuration of a mobile station according to the first embodiment. The mobile station 100 illustrated by example in FIG. 3 is provided with a transceiver 102 coupled to a transceiver antenna 101, and a transceiver 104 coupled to a transceiver antenna 103. The mobile station 100 is also provided with a signal processor 105 coupled to the transceivers 102 and 104, as well as signal processing work memory 106 and signal processing program memory 107 coupled to the signal processor 105. In addition, the mobile station 100 is provided with an application processor 108 coupled to the signal processor 105, as well as application memory 109 and an input/output device 110 coupled to the application processor 108.

The transceiver antenna 101 and the transceiver 102 are used to transmit and receive Band 1 signals. The transceiver antenna 103 and the transceiver 104 are used to transmit and receive Band 2 signals. In this way, the example in FIG. 3 includes separate transceiver antennas for the individual frequency bands Band 1 and Band 2. It is also possible to implement a single wideband transceiver antenna that covers a plurality of frequency bands instead of a plurality of transceiver antennas as above. Note that the transceiver 102 is an example of a first transceiver, and the transceiver 104 is an example of a second transceiver.

The signal processor 105 is a central processing section that controls the mobile station 100 overall. The signal processor 105 reads out various programs stored in the signal processing program memory 107, loads them into the signal processing work memory 106, and executes the programs. In so doing, various processes are executed so as to realize the functions of a mobile station 100. As discussed later, by executing programs the signal processor 105 realizes functions such as modulation and demodulation functions, reception quality measurement functions, control functions, restore determination functions, control information extraction functions, and restore quality storage functions. It is possible to realize the signal processor 105 by using a processor such as a central processing unit (CPU) or digital signal processor (DSP), or alternatively, by using a system-on-a-chip (SoC) that includes such a processor, for example. Functions realized by the signal processor 105, the signal processing work memory 106, and the signal processing program memory 107 may also be realized by a microcontroller or other specialized hardware circuit. Note that the signal processor 105 is an example of a control device.

The signal processing work memory 106 is a storage in which a work area is laid out by the signal processor 105. Semiconductor memory such as random access memory (RAM), for example, may be implemented as the signal processing work memory 106. The signal processing program memory 107 is a storage provided with a storage medium that stores various programs and various data. Storages such as read-only memory (ROM), erasable programmable ROM (EPROM), flash ROM (flash memory) and other semiconductor memory or magnetic recording media are potential examples of the signal processing program memory 107. Note that the signal processing work memory 106 is an example of a storage.

The application processor 108 is a processing section that conducts various processes on transmit and receive data related to various communication services that a mobile station is able to use. The application processor 108 processes transmit and receive data corresponding to communication services by executing various programs stored in the application memory 109. The application processor 108 may be realized by a processor such as a CPU or DSP, a SoC that includes such a processor, or by specialized hardware that uses a microcontroller, for example.

The application memory 109 is a storage provided with semiconductor memory such as RAM used as a work area for the application processor 108, as well as a non-volatile storage medium that stores various programs and various data used by the application processor 108. Storages such as ROM, EPROM, flash ROM and other semiconductor memory or magnetic recording media are potential examples of the non-volatile storage medium.

The input/output device 110 is provided with a display that displays text and video, a microphone and one or more speakers for inputting and outputting audio, a camera that records images (including video images), as well as a group of keys and buttons for inputting information (including application commands) supplied by the user of the mobile station 100.

A variety of mobile terminals such as mobile phones (cellular phones), smartphones, wireless LAN devices, and Bluetooth devices may be implemented as a mobile station, provided that the mobile terminal is able to communicate using two or more frequency bands. Such mobile terminals may also include personal computers (PCs) in notebook or tablet form factors and personal digital assistants (PDAs) with wireless communication functions.

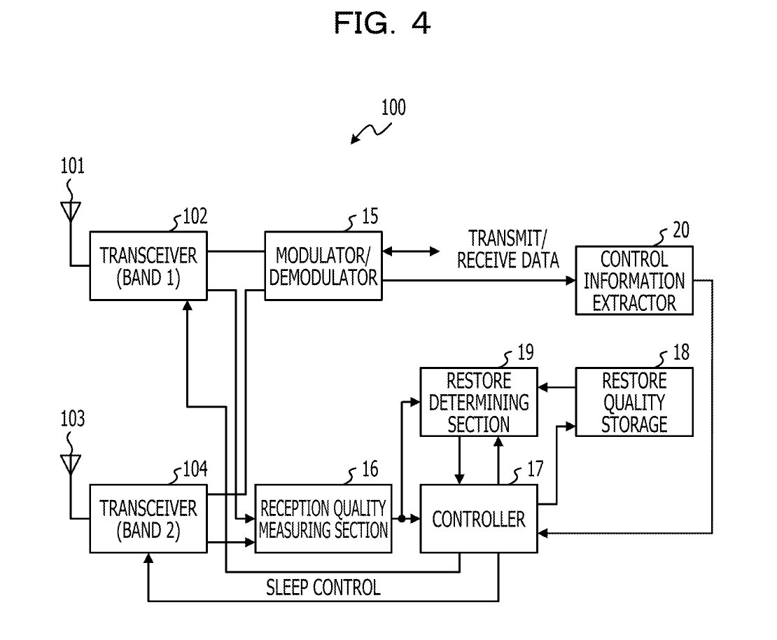

FIG. 4 illustrates exemplary function blocks realized by the signal processor 105 in the mobile station 100 illustrated in FIG. 3 executing programs. As discussed earlier, the signal processor 105 reads out various programs stored in the signal processing program memory 107, loads them into the signal processing work memory 106, and executes the programs. By executing programs in this way, the signal processor 105 of the mobile station 100 realizes the functions of a modulator/demodulator 15, a reception quality measuring section 16, a controller 17, restore quality storage 18, a restore determining section 19, and a control information extractor 20.

The transceiver antenna 101 receives a Band 1 radio wave (RF signal), and passes it to the Band 1 transceiver 102. The transceiver 102 is provided with non-illustrated components such as an amp, filter, mixer, and analog-to-digital (A/D) and digital-to-analog (D/A) converters, which execute receive processing such as down-conversion, amplification, and waveform shaping on the receive signal from the transceiver antenna 101, thereby converting the RF signal into a digital baseband signal. The digital baseband signal is input into the modulator/demodulator 15.

The modulator/demodulator 15 executes processing such as modulation and demodulation, encoding and decoding, and channel estimation on a digital baseband signal. A digital baseband signal contains user data (such as audio, images, video, and text) and control information. The modulator/demodulator 15 demodulates and otherwise processes a signal that has been processed by the transceiver 102 to obtain receive data. The modulator/demodulator 15 passes the receive data to the application processor 108.

Conversely, Band 1 transmit data supplied from the application processor 108 is modulated by the modulator/demodulator 15 according to a given modulation format, and a digital baseband signal is generated. The digital baseband signal is up-converted into a Band 1 (i.e., 2 GHz band) radio signal (RF signal) by transmit processing in the transceiver 102, and transmitted from the transceiver antenna 101.

The transceiver antenna 103 receives a Band 2 (i.e., 3.5 GHz band) radio wave (RF signal), and passes it to the Band 2 transceiver 104. The transceiver 104 has a similar configuration to the transceiver 102, and executes receive processing, including down-conversion, on a signal received by the transceiver antenna 103. The modulator/demodulator 15 demodulates and otherwise processes a digital baseband signal that has been obtained by receive processing in the transceiver antenna 103 to obtain receive data. The modulator/demodulator 15 passes the receive data to the application processor 108. Conversely, Band 2 transmit data supplied from the application processor 108 is converted into a digital baseband signal that has been modulated by the modulator/demodulator 15 according to a given modulation format. The resulting digital baseband signal is up-converted into a Band (i.e., 3.5 GHz) radio signal (RF signal) by transmit processing in the transceiver 104, and transmitted from the transceiver antenna 103.

The reception quality measuring section 16 uses signals output from the transceiver 102 and the transceiver 104 to measure the reception quality of signals in Band 1 and Band 2, respectively (i.e., reception quality is measured for each frequency band). The received signal strength indicator (RSSI) and the Carrier to Interference and Noise Ratio (CINR) are potential examples of the reception quality measured by the reception quality measuring section 16. Besides the indices given by example above, it is also possible to implement a signal to noise ratio (SNR), signal to interference ratio (SIR), propagation loss, or error rate (such as the bit error rate or block error rate) as the reception quality. The reception quality measuring section 16 measures the reception quality of Band 1 and Band 2 according to at least one among the plurality of reception quality indices given above. Measurement results for the reception quality of Band 1 and Band 2 (reception quality information) is input into the controller 17 and the restore determining section 19. Note that the reception quality measuring section 16 is an example of a measuring section.

The controller 17 controls operation of the transceivers 102 and 104 on the basis of instructions from an upper layer or received control information. Control information includes sleep control (low-power mode control). For example, the controller 17 may respectively apply a sleep control to the transceivers 102 and 104 on the basis of reception quality information provided by the reception quality measuring section 16 and respectively corresponding to Band 1 and Band 2. In other words, on the basis of reception quality information, the controller 17 respectively supplies the transceivers 102 and 104 with a control signal that induces a mode change in the transceivers 102 and 104. Potential modes include an operating mode (active state, active mode) and a sleep mode (low-power mode).

Operating mode is a state in which the transceivers 102 and 104 execute the receive processing and transmit processing discussed above. Meanwhile, sleep mode includes a first sleep mode called “deep sleep mode” and a second sleep mode called “intermittent listening mode”.

Deep sleep mode (first sleep mode) is a state in which receive processing and transmit processing in the transceivers 102 and 104 is prohibited, or alternatively, a state in which an idle state is enforced (i.e., signal input is ignored). Deep sleep mode also includes non-operating states of the transceivers 102 and 104, caused by temporarily terminating power supply to part or all of the transceivers 102 and 104. Since the transceivers 102 and 104 cease to operate as a result of entering deep sleep mode, power consumption by the transceivers 102 and 104 is reduced. Thus, a reduction in the power consumption of the mobile station 100 may be achieved.

The controller 17 is able to respectively put the transceivers 102 and 104 in deep sleep mode by supplying the transceivers 102 and 104 with a control signal in the form of a disable signal that disables receive processing and transmit processing, for example. In contrast, the controller 17 is able to respectively cancel deep sleep mode in the transceivers 102 and 104 (i.e., restore the transceivers 102 and 104 to operating mode) by supplying the transceivers 102 and 104 with a control signal in the form of an enable signal that enables receive processing and transmit processing.

Alternatively, the controller 17 may respectively cause the transceivers 102 and 104 to switch from operating mode to deep sleep mode by switching off a power supply switch (not illustrated) provided between a power source (not illustrated) inside the mobile station 100 and the transceivers 102 and 104. Likewise, the controller 17 may respectively cause the transceivers 102 and 104 to switch from deep sleep mode to operating mode by switching on the power supply switch. A semiconductor switch may be implemented as the power supply switch, for example, and placed at an appropriate position. For example, the transceivers 102 and 104 may be provided with semiconductor switches.

Meanwhile, intermittent listening mode (second sleep mode) is a state in which the transceivers 102 and 104 only execute a periodic receive process (search process). In intermittent listening mode, the function that suspends receive processing for a signal to be measured at a transceiver is temporarily canceled at given reception quality measurement timings (managed by a timer not illustrated), signal receive processing is conducted, and the reception quality of a received signal is measured. In the case where the reception quality is equal to or greater than a threshold value stored in advance, intermittent listening mode is canceled, and the transceiver is restored to operating mode. The controller 17 is able to respectively put the transceivers 102 and 104 into intermittent listening mode by supplying the transceivers 102 and 104 with a control signal.

In a mobile station 100 according to the first embodiment, when the Band 2 reception quality becomes less than or equal to a predetermined minimum reception quality, the controller 17 may generate a control signal for changing the Band 2 transceiver 104 from operating mode to sleep mode (i.e., a sleep signal), and supply the generated sleep signal to the transceiver 104 or to the power switch of the transceiver 104. At this point, the controller 17 takes the Band 1 reception quality information (i.e., a reception quality value) from the time when the Band 2 reception quality became less than or equal to the minimum reception quality, and stores the Band 1 reception quality information in the restore quality storage 18.

Band 1 reception quality information (i.e., a reception quality value) stored in the restore quality storage 18 is used as an index (such as a threshold value) for restoring the transceiver 104 from sleep mode to operating mode. Hereinafter, a Band 1 reception quality value which is stored in the restore quality storage 18 and which acts as an index for canceling a Band 2 sleep mode will be designated the “restore quality (value)”. Note that the restore quality storage 18 may be created in a storage area included in the signal processing work memory 106 (see FIG. 3), for example.

The restore determining section 19 receives Band 1 reception quality information generated by the reception quality measuring section 16, and compares the received reception quality to a restore quality stored in the restore quality storage 18. If the reception quality is less than the restore quality, the restore determining section 19 may not perform any particular processing. In contrast, if the reception quality has become equal to or greater than the restore quality, for example, the restore determining section 19 may notify the controller 17 that the reception quality has become equal to or greater than the restore quality. Upon receiving a notification from the restore determining section 19, the controller 17 issues a control signal to the transceiver 104, the control signal being a signal that cancels sleep mode in the transceiver 104, or in other words, restores the transceiver 104 to operating mode (i.e., a sleep cancel signal).

The control information extractor 20 extracts control information obtained by the modulator/demodulator 15 and passes extracted control information to the controller 17. Control information includes announce information and handover notifications.

[1.3. Sleep Control]

Next, a sleep control method for a transceiver 104 conducted by a mobile station 100 according to the first embodiment will be described in detail.

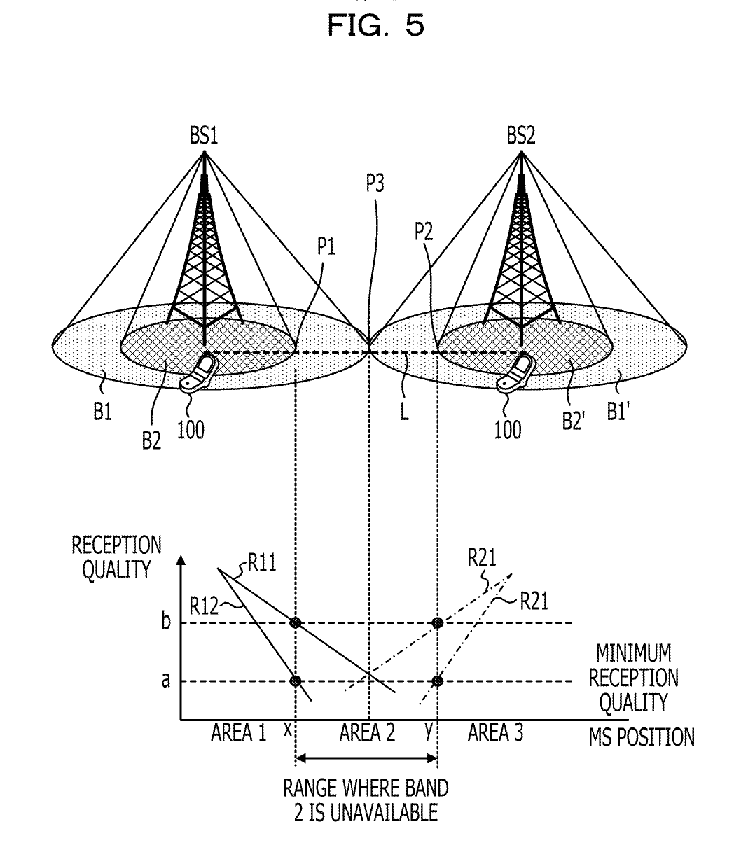

FIG. 5 illustrates relationships between the coverage areas B1, B2, B1′, and B2′ of the base stations BS1 and BS2 illustrated in FIG. 1, and the reception quality for each coverage area at a mobile station 100. The mobile station 100 controls sleep and restore for a transceiver on the basis of a corresponding reception quality measured by the reception quality measuring section 16. Hereinafter, an example of Band 2 sleep control in a mobile station 100 (Control Example 1) will be described using FIG. 5.

In FIG. 5, the coverage areas B1 and B2 as well as the coverage areas B1′ and B2′ are formed in similarly-sized concentric circles centered on the positions of the base stations BS1 and BS2, respectively, similarly to FIG. 1. The graph in the lower part of FIG. 5 illustrates the reception quality as the mobile station 100 moves along a line L (indicated by a broken line in FIG. 5) that joins the center of the coverage areas B1 and B2 with the center of the coverage areas B1′ and B2′.

The Band 1 coverage areas B1 and B1′ formed by the base stations BS1 and BS2 are adjacent to each other. The coverage area B1 and the coverage area B1′ are positioned adjacent to each other. P3 is the contact point between the coverage areas B1 and B1′. Consequently, the mobile station 100 is able to continue to use communication services using the Band 1 communication band when between the base station BS1 and the adjacent base station BS2. In FIG. 5, the base station BS1, a boundary point P1, a contact point P3, a boundary point P2, and the base station BS2 are positioned on the line L. The boundary point P1 is the boundary point between the coverage area B1 and the coverage area B2 formed by the base station BS1, while the boundary point P2 is the boundary point between the coverage area B1′ and the coverage area B2′ formed by the base station BS2.

The graph illustrated by example in FIG. 5 indicates exemplary reception quality at a mobile station 100 moving along the line L. In the graph in FIG. 5, the vertical axis represents the reception quality measured at the mobile station 100, while the horizontal axis represents the position of the mobile station (MS) 100 on the line L.

The lines R11 and R12 depicted in the graph in FIG. 5 indicate changes in the reception quality of respective Band 1 and Band 2 signals received by the mobile station 100 from the base station BS1. Meanwhile, the lines R21 and R22 indicate the reception quality of respective Band 1 and Band 2 signals received by the mobile station 100 from the base station BS2. Note that actual reception quality does not change linearly according to the distance between the mobile station 100 and the base station BS1 or BS2, and is rather a combination of several functions that decrease with powers of the distance. However, since such behavior does not affect a control method according to the disclosed technology, changes in reception quality are schematically represented by straight lines herein.

When the mobile station 100 is positioned at or near the center of the coverage areas B1 and B2 (or B1′ and B2′), the respective Band 1 and Band 2 reception qualities measured by the reception quality measuring section 16 of the mobile station 100 both express their maximum respective values. As the mobile station 100 moves from base station BS1 to base station BS2 or vice versa, the reception qualities decrease as the distance separating the mobile station 100 from the base station BS1 or BS2 increases. However, due to differences in Band 1 and Band 2 propagation characteristics, the slope of the rate at which the Band 1 reception quality decreases is gentler than the slope of the rate at which the Band 2 reception quality decreases.

The lines R11 and R12 in FIG. 5 demonstrate how the reception qualities decrease as the mobile station 100 moves away from the position of the base station BS1 inside the coverage area B2 (Area 1 in FIG. 5). Then, upon reaching the boundary point P1, the Band 2 reception quality measured at the mobile station 100 becomes a minimum reception quality “a” stipulated in advance for the mobile station 100 (i.e., a minimum reception quality with which the mobile station 100 is able to stay coupled to a base station).

If the reception quality falls below the minimum reception quality a, the mobile station 100 may become unable to communicate using Band 2. For this reason, the controller 17 of the mobile station 100 puts the Band 2 transceiver 104 into sleep mode (deep sleep mode) in order to conserve power. At this point, the controller 17 takes the Band 1 reception quality “b” from the time when the Band 2 reception quality became the minimum reception quality a (i.e., the time when the transceiver 104 entered sleep mode), and stores the reception quality b in the restore quality storage 18.

When the mobile station 100 moves past the boundary point P1 towards the boundary point P2 (Area 2 in FIG. 5), the mobile station 100 may only be able to receive Band 1 signals from at least one of the base stations BS1 and BS2. Consequently, the reception quality measuring section 16 only measures Band 1 reception quality. Meanwhile, once the mobile station 100 passes the contact point P3 and the reception quality from the base station BS2 surpasses the reception quality from the base station BS1, a handover from the base station BS1 to the base station BS2 is conducted at a suitable timing (such as when the reception quality from the base station BS1 becomes equal to the minimum reception quality a).

The Band 1 reception quality at the mobile station 100 after having passed the contact point P3 (indicated by the line R21 in FIG. 5) improves as the mobile station 100 approaches the base station BS2. Furthermore, when the mobile station 100 passes the boundary point P2 and enters the coverage area B2′ (Area 3 in FIG. 5), the Band 2 reception quality measured at the mobile station 100 surpasses the minimum reception quality a.

However, the transceiver 104, which entered sleep mode triggered by separation from the coverage area B2, is not processing received signals (radio waves) from the base station BS2. In other words, since the Band 2 reception quality is not being measured, sleep mode is not canceled on the basis of the Band 2 reception quality.

Thus, in Area 2 of FIG. 5 (i.e., the area between boundary points P1 and P2), the restore determining section 19 of the mobile station 100 monitors Band 1 reception quality and continually compares it to the restore quality b. The restore determining section 19 then notifies the controller 17 when the Band 1 reception quality reaches the restore quality (i.e., the reception quality b) as a result of the mobile station 100 reaching the boundary point P2. Upon being notified, the controller 17 cancels sleep mode in the transceiver 104. The transceiver 104, having entered operating mode as a result of sleep mode being canceled, conducts a Band 2 search process. At this point, since the mobile station 100 is inside the coverage area B2′, the Band 2 reception quality is equal to or greater than the minimum reception quality a. Consequently, the mobile station 100 initiates an attach procedure using announce information from the base station BS2, and becomes able to make use of communication services using Band 2.

According to the above Band 2 sleep control, the Band 1 reception quality b from the time when the Band 2 sleep mode starts (i.e., the time when the Band 2 reception quality becomes the minimum reception quality a) is stored as a restore quality. The restore quality is used as an index for canceling sleep mode, such that a Band 2 sleep mode is canceled when the Band 1 reception quality reaches the restore quality b.

Thus, it is possible for the mobile station 100 to avoid executing a periodic Band 2 search process (i.e., operating in intermittent listening mode) while in an area where Band 2 signals may not be received (i.e., Area 2). By avoiding execution of a search process, power that would be consumed by the search process can be conserved. Thus, lower power consumption in the mobile station 100 may be achieved.

Herein, since the mobile station 100 is able to use both Band 1 and Band 2 in the coverage area B2′, it is possible to use wideband communication services that utilize both frequency bands.

The example illustrated in FIG. 5 (Control Example 1) has been described under the presumption that the coverage areas B1 and B2 formed by the base station BS1 and the coverage areas B1′ and B2′ formed by the base station BS2 are of similar size. In some cases, however, differences in the environment surrounding the locations where the base stations BS1 and BS2 are installed may cause the Band 1 signal propagation characteristics to change greatly when triggered by a base station handover, even if a mobile station 100 between the base stations BS1 and BS2 is able to continue communicating using Band 1, for example.

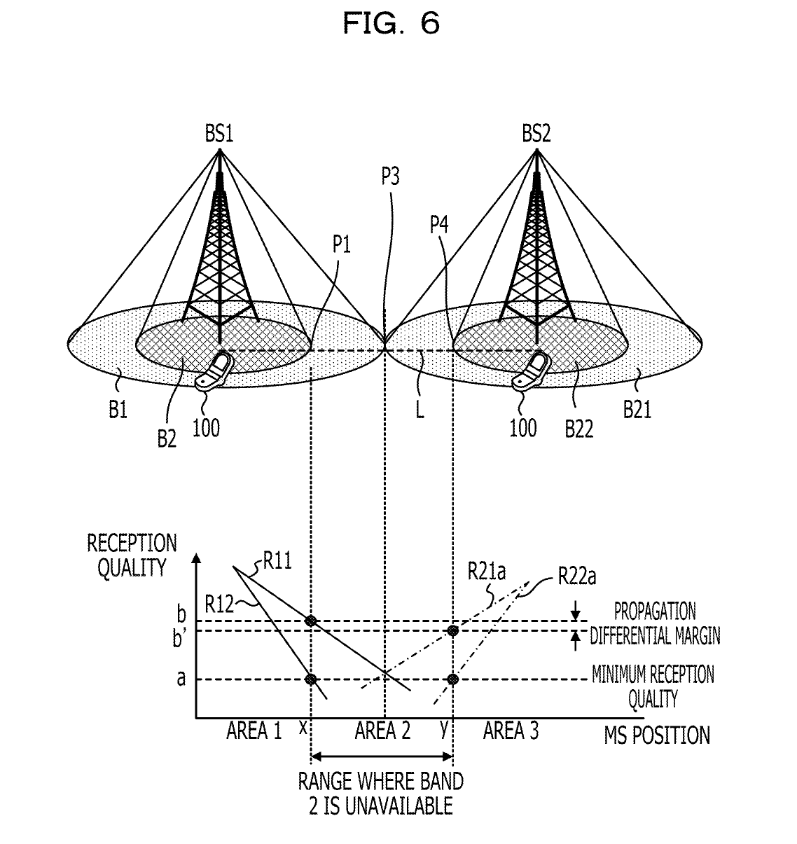

FIG. 6 illustrates sleep control in the case where signal propagation characteristics vary between base stations (i.e., the coverage areas are different in size). FIG. 6 is a diagram for explaining reception quality in the case where the service areas provided by adjacent base stations differ from each other (Control Example 2).

In the example illustrated in FIG. 6, the base station BS2 has a Band 1 coverage area B21 and a Band 2 coverage area B22, with the coverage areas B21 and B22 formed in concentric circles centered on the position of the base station BS2. The coverage areas B21 and B22 are larger in size than the coverage areas B1 and B2 of the base station BS1. P4 is the boundary point between the coverage areas B21 and B22 formed by the base station BS2. The coverage area B21 touches the coverage area B1 at a contact point P3. Similarly to FIG. 5, it is assumed that a mobile station 100 moves along a line L that joins the base station BS1, a boundary point P1, the contact point P3, the boundary point P4, and the base station BS2.

As discussed earlier, it is assumed that the coverage area B21 is larger than the coverage area B1, that the coverage area B22 is larger than the coverage area B2, and that the slopes of the lines R21a and R22a, which indicate the change in the respective Band 1 and Band 2 reception qualities measured at the mobile station 100 while moving along the line L inside the coverage areas B21 and B22, are gentler than the slopes of the lines R11 and R12, which indicate the reception qualities measured in the coverage areas B1 and B2. The differences in the slopes are due to differences in propagation characteristics.

Similarly to the example illustrated in FIG. 5, herein it is assumed that when the Band 2 reception quality becomes the minimum reception quality a while in the coverage areas of the base station BS1, the Band 1 reception quality b at that time is stored as the restore quality, and the transceiver 104 is put into sleep mode.

As the mobile station 100 moves along the line L from the base station BS1 towards the base station BS2, the Band 2 reception quality reaches the minimum reception quality a at the time when the mobile station 100 reaches the boundary point P4, as illustrated in FIG. 6. In contrast, since the slope of the line R21a is gentler than that of the line R11, the Band 1 reception quality becomes a reception quality b′ that is lower than the restore quality b at the time when the mobile station 100 reaches the boundary point P4. Consequently, the Band 1 reception quality reaches the restore quality b at a point after the mobile station 100 has passed the boundary point P4 by some distance. In other words, the time at which sleep mode is canceled (i.e., the time of restoration to operating mode) is delayed.

An example of Band 2 sleep control for the mobile station 100 in FIG. 6 that can avoid delay like the above (Control Example 2) will now be described. At the boundary point P1 illustrated in FIG. 6, the reception quality measuring section 16 of the mobile station 100 measures the Band 2 minimum reception quality a, and also measures the Band 1 reception quality b.

When triggered by detection of the Band 2 minimum reception quality a, the controller 17 of the mobile station 100 computes a reception quality b′ by subtracting a propagation differential margin m from the Band 1 reception quality “b”, and stores the computed reception quality b′ in the restore quality storage 18 as the restore quality. The propagation differential margin m is indicative of the difference in propagation characteristics between the base stations BS1 and BS2, and may be computed in advance by real-world testing, for example. Having acquired the reception quality b, the controller 17 uses the preset propagation differential margin m to compute the restore quality b′, and stores the computed reception quality b′ in the restore quality storage 18 as the restore quality. The propagation differential margin m may be included in control information received from the serving base station, such as in the announce information, for example. The control information extractor 20 extracts the propagation differential margin m from announce information obtained by the modulator/demodulator 15 and passes the extracted information to the controller 17. The controller 17 may retain the propagation differential margin m and use it to compute the restore quality.

When moving from boundary point P1 to P4, the mobile station 100 conducts a handover from the serving base station BS1 to the target base station BS2 at a suitable timing after passing the contact point P3.

In Control Example 2, control is applied to immediately put the transceiver 104 in sleep mode (deep sleep mode) upon detecting the Band 1 minimum reception quality a, similarly to Control Example 1. However, in Control Example 2, it is preferable to apply control to switch the transceiver 104 to intermittent listening mode rather than deep sleep mode while the Band 1 reception quality is equal to or greater than the reception quality b′ (i.e., the restore quality). The reasons for this are as follows.

In Control Example 2, the mobile station 100 exiting the coverage area B2 causes a restore quality b′ that is lower than the reception quality b to be stored in the restore quality storage 18. If the transceiver 104 enters deep sleep mode in such a situation, deep sleep mode will be canceled by the restore quality b′, similarly to Control Example 1. However, it is conceivable that after having gone outside the coverage area B2, the mobile station 100 may once again move back into the coverage area B2 without moving towards the coverage area B2′. In this case, the restore quality b′ is reached before the Band 1 reception quality becomes equal to the reception quality b indicative of the mobile station 100 reaching the boundary point P1 of the coverage area B2, and deep sleep mode is canceled.

The transceiver 104 conducts a search process triggered by the canceling of deep sleep mode. However, since the Band 2 reception quality has not reached the minimum reception quality a, Band 2 announce information may not be received normally, and a normal Band 2 attach procedure with the base station BS1 may not be conducted. In light of such problems, in Control Example 2, the transceiver 104 enters intermittent listening mode while the reception quality is equal to or greater than the reception quality b′, and switches to deep sleep mode when the reception quality becomes less than the reception quality b′. From this state, if the Band 1 reception quality subsequently becomes equal to or greater than the reception quality b′, the transceiver 104 switches back to intermittent listening mode.

Consequently, a mobile station 100 positioned between the boundary point P1 and the boundary point P4 (Area 2 in FIG. 6) enters intermittent listening mode when the Band 1 reception quality is equal to or greater than the restore quality b′, regardless of whether the mobile station 100 is moving towards the coverage area B2 or the coverage area B22. Thus, it becomes possible for the mobile station 100 to normally receive Band 2 announce information via a search process conducted in intermittent listening mode, and restore the transceiver 104 to operating mode.

The above Control Example 2 describes the case of a mobile station 100 moving from a base station BS1 towards a base station BS2. In the opposite case, or in other words the case of a mobile station 100 moving from the base station BS2 (i.e., the coverage area B22) towards the base station BS1 (i.e., the coverage area B2), the Band 1 reception quality corresponding to the Band 2 minimum reception quality a becomes equal to the reception quality b′. In this case, restore quality operations using the propagation differential margin m are not executed, and the reception quality b′ is stored directly as the restore quality b′

[1.4. Sleep Control Process Examples]

[1.4.1. Process Example 1]

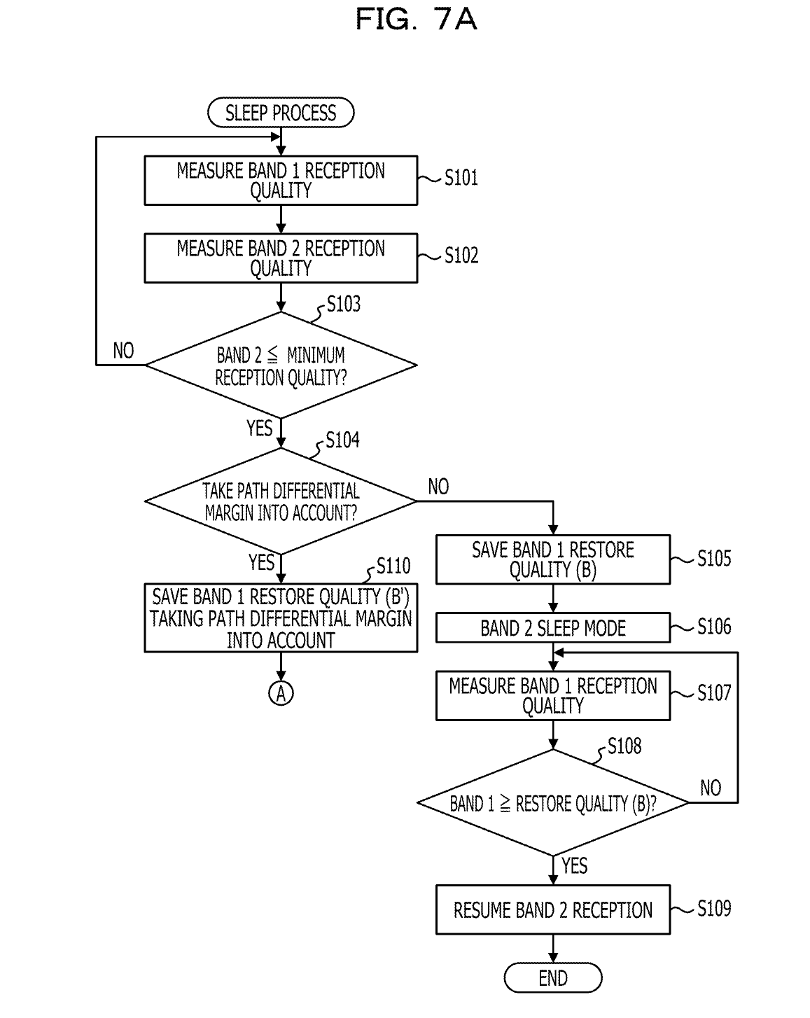

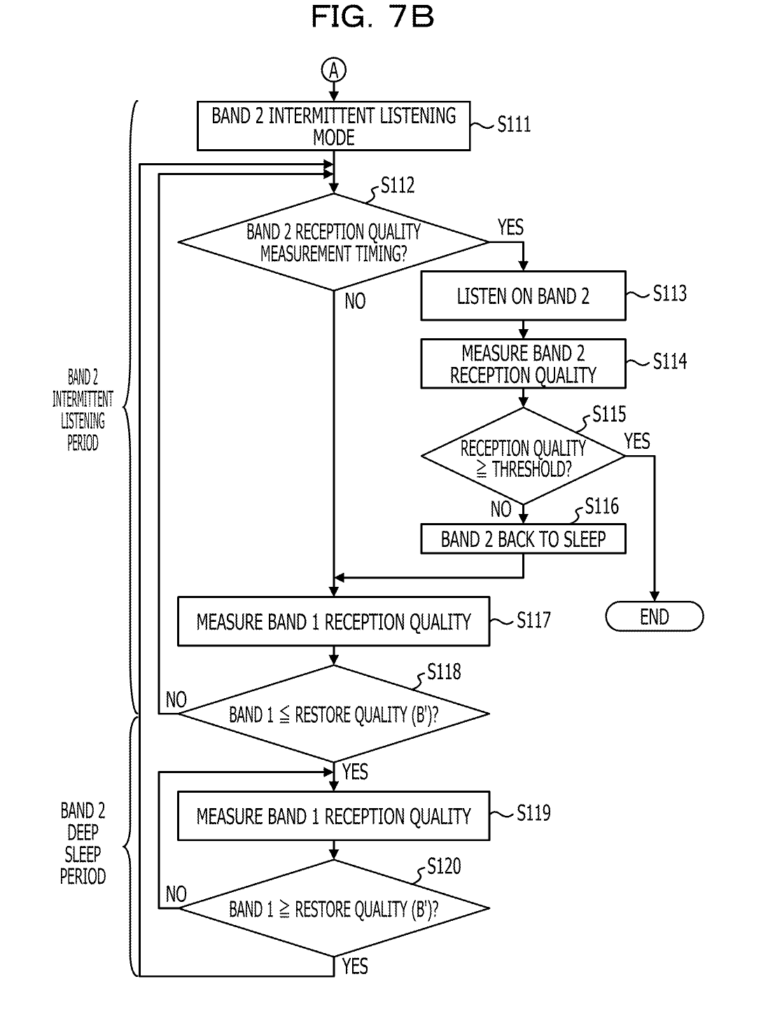

FIGS. 7A and 7B are flowcharts illustrating a Process Example 1 for sleep control applied by a mobile station 100. The process illustrated by example in FIGS. 7A and 7B is an exemplary sleep control corresponding to the Control Examples 1 and 2 described using FIGS. 5 and 6. Unless specifically stated otherwise, the operations and processes in the following description of FIGS. 7A and 7B are operations and processes conducted by the signal processor 105 of a mobile station 100.

Assume that when the flowchart in FIG. 7A starts, the transceivers 102 and 104 of the mobile station 100 are in operating mode, and that the mobile station 100 is inside the coverage area B2 of the base station BS1 (see FIGS. 5 and 6).

The signal processor 105 functions as the reception quality measuring section 16 to measure the reception quality of each frequency band. In other words, the signal processor 105 measures the reception quality of Band 1 signals received by the transceiver 102 from the base station BS1 (S101), and also measures the reception quality of Band 2 signals received by the transceiver 104 from the base station BS1 (S102).

The signal processor 105 functions as the controller 17 to determine whether or not the Band 2 reception quality is less than or equal to a predetermined minimum reception quality (S103). For example, the minimum reception quality may be the minimum reception quality “a” illustrated by example in FIGS. 5 and 6.

The signal processor 105 (i.e., the controller 17) returns the process to step S101 in the case where the value of the Band 2 reception quality exceeds the value of the minimum reception quality (S103, No). Note that steps S101 and S102 may also be executed in reverse order or in parallel.

The processing loop from step S101 to S103 is repeatedly executed while the mobile station 100 is inside the coverage area B2. In contrast, when the mobile station 100 exits the coverage area B2, it is determined in step S103 that the Band 2 reception quality is less than or equal to the minimum reception quality (S103, Yes).

In this case, the signal processor 105 functions as the controller 17 to determine whether or not to take a path differential margin into account (S104). The path differential margin may be the propagation differential margin m illustrated in FIG. 6, for example.

The path differential margin may be included in announce information from a serving base station (such as the base station BS1), for example. The signal processor 105 functions as the control information extractor 20 to extract the path differential margin from announce information obtained by the modulator/demodulator 15 and store the path differential margin in the signal processing work memory 106, for example. Then, in step S104, the signal processor 105 determines that the path differential margin is to be taken into account if a path differential margin is being stored, and determines that the path differential margin is not to be taken into account if a path differential margin is not being stored.

In the case where the path differential margin is not to be taken into account (S104, No), the signal processor 105 of the mobile station 100 functions as the controller 17 to take the Band 1 reception quality (i.e., reception quality information) from the time when it was determined that the Band 2 reception quality is less than or equal to the minimum reception quality a, and save the reception quality information in a work area of the signal processing work memory 106 provided as the restore quality storage 18 (S105). The saved reception quality information (i.e., the restore quality) may be the reception quality “b” in FIGS. 5 and 6, for example.

The signal processor 105 functions as the controller 17 to put the Band 2 transceiver 104 into sleep mode (S106). Subsequently, the signal processor 105 functions as the reception quality measuring section 16 to continue measuring the Band 1 reception quality (S107), and functions as the restore determining section 19 to compare the Band 1 reception quality to the restore quality “b” (S108).

If the measured reception quality is less than the restore quality b (S108, No), the process returns to step S107 and the processing loop from step S107 to S108 is repeated. For example, given the coverage areas illustrated by example in FIG. 5, the above processing loop is executed in the case where the mobile station 100 is positioned between the boundary point P1 and the boundary point P2.

In contrast, if the measured reception quality is equal to or greater than the restore quality b (S108, Yes), the signal processor 105 functions as the controller 17 to cancel sleep mode, thus restoring the Band 2 transceiver 104 to operating mode (S109). In so doing, the transceiver 104 resumes processing Band 2 signals via execution of a Band 2 search process. The Yes determination in step S108 is returned when the mobile station 100 enters the coverage area B2′ in FIG. 5, for example.

The above processing from steps S101 to S103 and from steps S105 to S109 are equivalent to Control Example 1 that was described using FIG. 5. Meanwhile, the processing from steps S101 to S103 and from steps S110 to S120 discussed below are equivalent to Control Example 2 that was described using FIG. 6.

When a Yes determination is returned in step S104, the signal processor 105 functions as the controller 17 to save a restore quality that takes the path differential margin into account (S110). For example, assume that the mobile station 100 has exited the coverage area B2 illustrated in FIG. 6. In this case, the signal processor 105 (i.e., the controller 17) computes a restore quality b′ by subtracting the path differential margin m from the Band 1 reception quality b corresponding to the Band 2 minimum reception quality a, and saves the computed restore quality b′ in the signal processing work memory 106 (i.e., the restore quality storage 18). Conversely, in the case where the mobile station 100 has exited the coverage area B22, restore quality operations using a path differential margin are not executed, and the reception quality b′ corresponding to the minimum reception quality a is saved directly as the restore quality b′.

The signal processor 105 functions as the controller 17 to put the Band 2 transceiver 104 into intermittent listening mode (S111). In intermittent listening mode, the transceiver 104 conducts a Band 2 signal search process (S113) upon reaching a Band 2 reception quality measurement timing (S112, Yes).

The signal processor 105 functions as the reception quality measuring section 16 to measure the Band 2 reception quality (S114). If the reception quality is equal to or greater than a preset threshold value (S115, Yes), the signal processor 105 functions as the controller 17 to cancel intermittent listening mode and restore the transceiver 104 to operating mode (i.e., terminate sleep mode).

In contrast, if the Band 2 reception quality is less than the threshold value (S115, No), the transceiver 104 stays in intermittent listening mode and waits for the next reception quality measurement timing according to a clock using a timer included in the signal processor 105 (S116). After that, the process proceeds to step S117.

Meanwhile, the signal processor 105 proceeds to step S117 from step S112 in the case of determining that a Band 2 reception quality measurement timing has not been reached (S112, No).

In step S117, the signal processor 105 functions as the reception quality measuring section 16 to measure the Band 1 reception quality. Subsequently, the signal processor 105 functions as the restore determining section 19 to determine whether or not the reception quality measured in step S117 is less than or equal to the restore quality b′ that was stored in step S110 (S118).

If the Band 1 reception quality surpasses the restore quality b′ (S118, No), the process returns to step S112 and intermittent listening mode is maintained. In contrast, if the Band 1 reception quality is less than or equal to the restore quality b′ (S118, Yes), the signal processor 105 functions as the controller 17 to put the transceiver 104 into deep sleep mode.

The signal processor 105 then measures the Band 1 reception quality (S119) and determines whether or not the reception quality is greater than or equal to the restore quality b′ (S120). In this way, the transceiver 104 is kept in deep sleep mode while the Band 1 reception quality is less than the restore quality b′ (i.e., the loop from S119 to S120). In contrast, if the Band 1 reception quality becomes equal to or greater than the restore quality b′ (S120, Yes), the process returns to step S112 and the transceiver 104 is switched to intermittent listening mode. After that, the transceiver 104 is ultimately restored to operating mode via intermittent listening mode.

[1.4.2. Process Example 2]

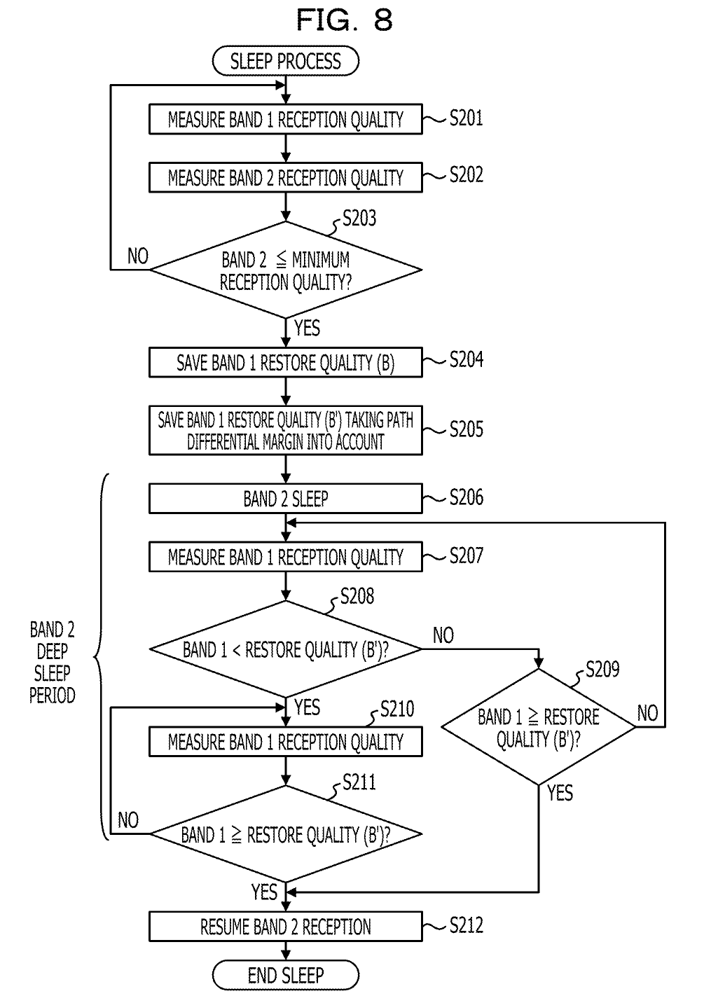

FIG. 8 is a flowchart illustrating a Process Example 2 for a sleep control process in a mobile station 100. Process Example 2 differs from Process Example 1 in that Process Example 2 omits the switch to intermittent listening mode conducted in Process Example 1 illustrated in FIGS. 7A and 7B. Since Process Example 2 includes some features in common with Process Example 1, just the differences will be primarily described hereinafter.

In the flowchart illustrated by example in FIG. 8, the processing from steps S201 to S203 are the same as the processing from steps S101 to S103 in the flowchart illustrated by example in FIG. 7A, and thus description thereof is omitted.

Steps S204 and S205 differ from Process Example 1 (FIGS. 7A and 7B) in that the signal processor 105 functions as the controller 17 to store both the Band 1 reception quality corresponding to the Band 2 minimum reception quality a as well as a corrected reception quality that takes the path differential margin m into account in the restore quality storage 18.

For example, in the case where the Band 2 reception quality becomes less than or equal to the minimum reception quality a due to the mobile station 100 moving away from the coverage area B2 of the base station BS1, the value of the Band 1 reception quality b corresponding to the Band 2 minimum reception quality a and the value of a reception quality b′ obtained by subtracting the path differential margin m from the reception quality b are stored in the restore quality storage 18 as the first restore quality b and the second restore quality b′, respectively.

After that, the signal processor 105 functions as the controller 17 to put the transceiver 104 into deep sleep mode (S206). The signal processor 105 then functions as the reception quality measuring section 16 to measure the Band 1 reception quality (S207).

In step S208, the signal processor 105 functions as the restore determining section 19 to determine whether or not the Band 1 reception quality is less than the second restore quality b′. At this point, if the Band 1 reception quality is equal to or greater than the second restore quality b′ (S208, No), the signal processor 105 functions as the restore determining section 19 to determine whether or not the Band 1 reception quality is equal to or greater than the first restore quality b (S209).

If the Band 1 reception quality is less than the first restore quality b (S209, No), the process returns to step S207. In contrast, if the Band 1 reception quality is equal to or greater than the first restore quality b (S209, Yes), the signal processor 105 functions as the controller 17 to restore the transceiver 104 from deep sleep mode to operating mode (step S212). In so doing, reception of Band 2 signals is resumed, and the sleep process in FIG. 8 ends.

Meanwhile, in the case where the Band 1 reception quality is less than the second restore quality b′ in step S208 (S208, Yes), the Band 1 reception quality is measured in step S210. Additionally, the signal processor 105 functions as the restore determining section 19 to determine whether or not the measured Band 1 reception quality is equal to or greater than the second restore quality b′ (S211).

At this point, if the Band 1 reception quality is less than the second restore quality b′ (S211, No), the process returns to step S210, and the processing loop from step S210 to S211 is repeated until a Yes determination is returned in step S211. If the Band 1 reception quality becomes equal to or greater than the second restore quality b′, the process proceeds to step S212, deep sleep mode is canceled, and the transceiver 104 switches to operating mode.

In Process Example 2, a No determination may be returned in step S208 if it is assumed that, for example, a mobile station 100 which has exited the coverage area B2 illustrated in FIG. 6 once again moves towards the coverage area B2. For this reason, the determination made in step S209 regarding whether or not the Band 1 reception quality has reached a restore quality is conducted using the first restore quality b corresponding to the coverage area B2.

In contrast, a Yes determination may be returned in step S208 if it is assumed that a mobile station 100 has moved away from the coverage area B2 and is moving towards the coverage area B22. Consequently, the determination made in step S211 regarding whether or not the Band 1 reception quality has reached a restore quality is conducted using the second restore quality b′ corresponding to the coverage area B22.

According to such a Process Example 2, a mobile station 100 that has moved away from a coverage area B2 is able to suitably cancel deep sleep mode in both the case of returning to the coverage area B2 and the case of moving to a coverage area B22.

[1.5. Advantages of First Embodiment]

According to Control Example 1 for a mobile station 100 according to the first embodiment, when circumstances change from a state in which both Band 1 and Band 2 are available to a state in which only Band 1 is available, the Band 1 reception quality is stored as a restore quality, while the Band 2 transceiver 104 is put into deep sleep mode. Deep sleep mode is subsequently canceled when triggered by the Band 1 reception quality becoming equal to or greater than the restore quality. In so doing, it is possible to avoid the periodic execution of non-continuous receive processing in intermittent listening mode. Consequently, power that would be consumed by the non-continuous receive processing can be conserved, and it may be possible to reduce the power consumption of the mobile station 100.

Additionally, according to Control Example 2 (Process Example 1) for a mobile station 100, in the case of non-uniform signal propagation characteristics (propagation paths) between base station coverage areas, a Band 1 reception quality adjusted for the propagation differential (path differential) margin (i.e., a reception quality that takes such a margin into account) is stored as a restore quality.

Furthermore, the transceiver 104 stays in deep sleep mode while the Band 1 reception quality is less than or equal to the restore quality, and enters intermittent listening mode when the restore quality is surpassed. Thus, the transceiver 104 can be suitably restored from sleep mode to operating mode in both the case where a mobile station 100 that has moved away from a Band 2 coverage area returns to the original coverage area as well as the case where the mobile station 100 moves to another Band 2 coverage area. Moreover, according to Control Example 2 (Process Example 2) for a mobile station 100, intermittent listening mode in the transceiver 104 may be skipped, thereby conserving more power compared to Process Example 1.

[1.6. Modifications]

In a mobile station 100 according to the first embodiment, if sleep control according to Control Example 1 is conducted such that a restore quality b is saved and the transceiver 104 is put into deep sleep mode, there may occur situations in which the Band 1 reception quality falls below a minimum reception quality and the Band 1 reception quality can no longer be measured (such as in the case where the mobile station 100 moves outside the coverage areas B1 and B1′, for example). In such cases, the signal processor 105 of the mobile station 100 controls the transceiver 102 to periodically conduct a Band 1 search process in order to be able to resume Band 1 communication. Meanwhile, the signal processor 105 switches the Band 2 transceiver 104 from deep sleep mode to intermittent listening mode without waiting for the Band 1 reception quality to reach the restore quality.

In so doing, it becomes possible to avoid a situation in which the Band 2 sleep mode is not canceled because of an inability to measure the Band 1 reception quality, such as when the mobile station 100 moves outside a Band 1 coverage area while in a Band 2 sleep mode, and subsequently enters a Band 2 coverage area while Band 1 reception has not been resumed.

### 2. Second Embodiment

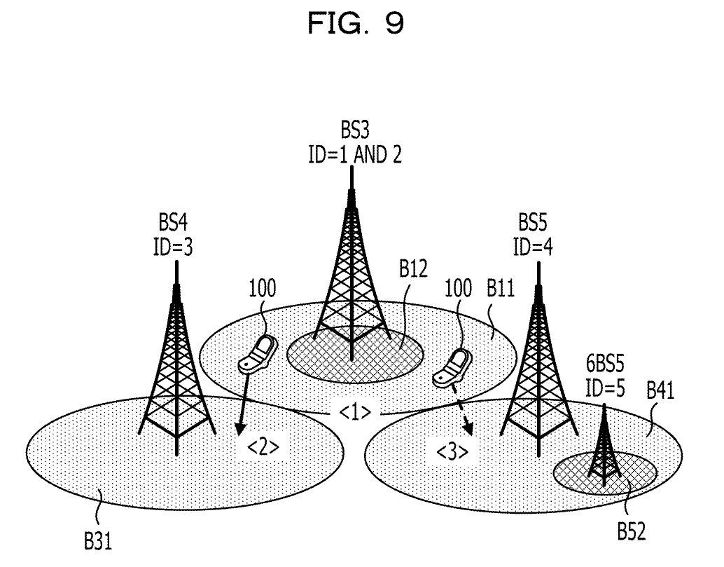

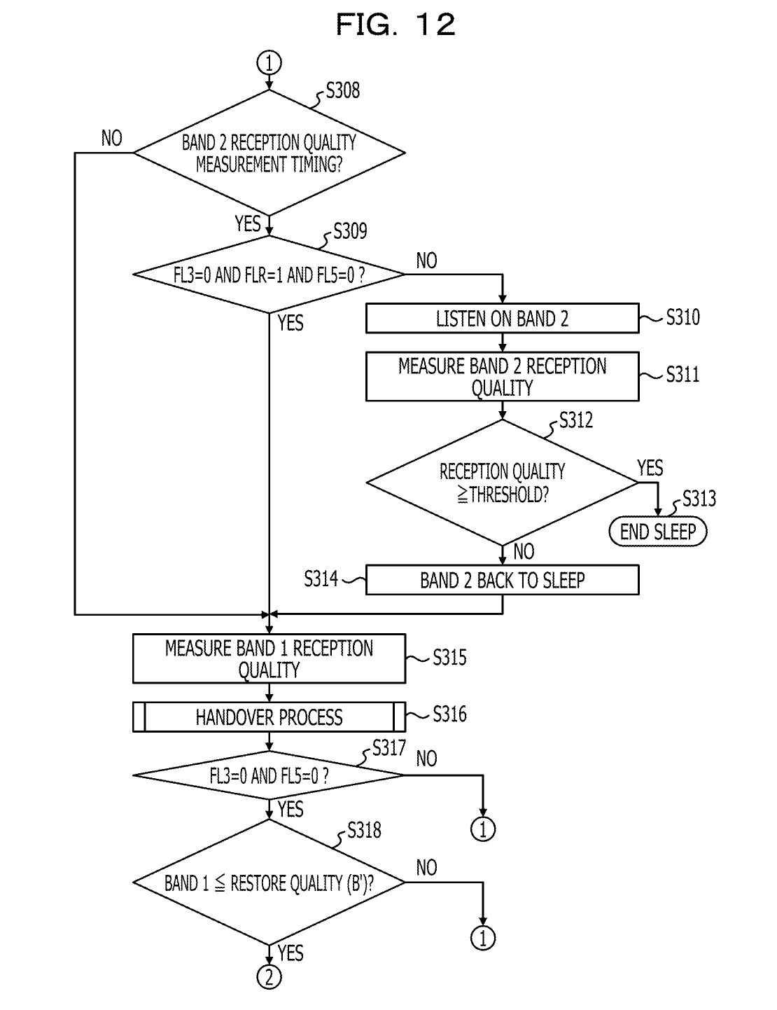

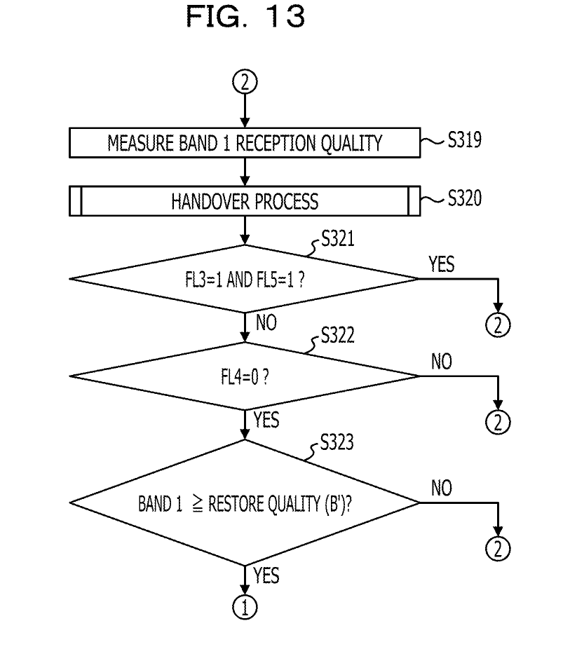

Next, a mobile station in accordance with a second embodiment will be described with reference to FIGS. 9 to 13. Since the configuration of the second embodiment shares some features in common with the first embodiment, the differences will be primarily described. A mobile station 100 according to the second embodiment is configured similarly to that described for the first embodiment (see FIGS. 3 and 4). For this reason, detailed description of the configuration is omitted.

[2.1. Coverage Areas]

FIG. 9 illustrates a distribution of Band 1 and Band 2 coverage areas assumed for the sake of describing the second embodiment. In FIG. 9, base stations BS3 to BS6 forming at least one of Band 1 and Band 2 coverage areas (cells) are depicted.

The base station BS3 forms both Band 1 and Band 2 coverage areas, similarly to the base stations BS1 and BS2 in the first embodiment. Specifically, a Band 1 coverage area B11 and a Band 2 coverage area B12 are concentrically formed centered on the position of the base station BS3. The coverage areas B11 and B12 constitute an area <1> in which joint service is provided by a Band 1 base station and a Band 2 base station.

The base station BS4 forms a Band 1 coverage area B31 adjacent to the coverage area B11 of the base station BS3. The coverage area B31 constitutes an area <2> in which joint service is not provided by a Band 2 base station, and in which there is no Band 2 service nearby.

The base station BS5 forms a Band 1 coverage area B41 adjacent to the coverage area B11 of the base station BS3. The base station BS6 forms a local Band 2 coverage area B52 inside the coverage area B41. The coverage area B41 constitutes an area <3> in which a nearby Band 2 base station exists, but which does not provide joint service with a Band 1 base station.

The base stations BS3 to BS6 are assigned unique base station identifiers (base station IDs). In the example illustrated in FIG. 9, the base station BS3 is assigned the base station ID “1” (for Band 1) and the base station ID “2” (for Band 2). The base stations BS4 to BS6 are assigned the base station IDs “3”, “4”, and “5”, respectively. The mobile station 100 illustrated in FIG. 9 is the mobile station 100 described in the first embodiment.

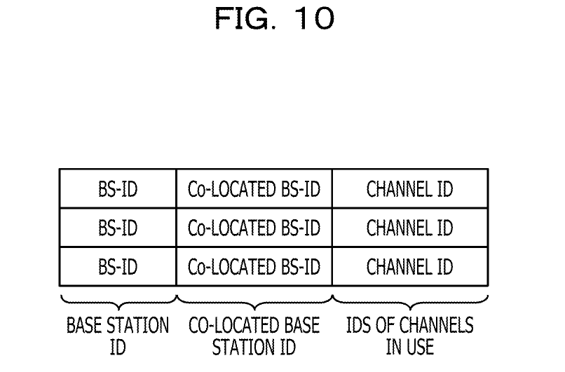

FIG. 10 illustrates partial announce information received by the mobile station 100 from a base station. The announce information is a signal transmitted by a base station to a mobile station, and includes information used by a mobile station to register its position. FIG. 10 illustrates information on base stations near the serving base station (nearby base station information), which is included in the announce information. The nearby base station information includes one or more records. Each record includes the following elements: the base station ID of a nearby base station (BS-ID), the base station ID of a base station that is co-located with the nearby base station (Co-located BS-ID), and one or more channel IDs (i.e., frequency band information).

For example, nearby base station information contained in Band 1 announce information announced by the base station BS4 and the base station BS5 includes a first record regarding the base station with BS-ID 1 (i.e., the Band 1 portion of the base station BS3), and a second record regarding the base station with BS-ID 2 (i.e., the Band 2 portion of the base station BS3).

The first record includes the following elements: a BS-ID 1, a co-located BS-ID 2, and channel IDs for one or more channels used by the base station with BS-ID 1 (i.e., Band 1 channel IDs). The second record includes the following elements: a BS-ID 2, a co-located BS-ID 1, and channel IDs for one or more channels used by the base station with BS-ID 2 (i.e., Band 2 channel IDs). Upon obtaining such nearby base station information, the signal processor 105 of the mobile station 100 is able to recognize the existence of a Band 2 base station with BS-ID 2 that is co-located with a Band 1 base station with BS-ID 1.

Meanwhile, nearby base station information contained in Band 1 announce information announced by the base station BS3 includes a first record regarding the base station BS4, which includes a BS-ID 3, an empty (null) co-located BS-ID, and corresponding channel IDs (for Band 1), a second record regarding the base station BS5, which includes a BS-ID 4, an empty co-located BS-ID, and corresponding channel IDs (for Band 1), and a third record regarding the base station BS6, which includes a BS-ID 5, an empty co-located BS-ID, and corresponding channel IDs (for Band 2). Upon obtaining such nearby base station information, the signal processor 105 of the mobile station 100 is able to recognize that although a Band 2 base station co-located with a Band 1 base station does not exist, an independent Band 2 base station does exist. Nearby base station information may also include that associates specific base stations with each other. For example, information associating the base station BS5 and the base station BS6 may be included. Nearby base station information is acquired by the control information extractor 20 (see FIG. 4) and provided to the controller 17.

In cases where both a BS-ID and a co-located BS-ID are stated in a single record, it may be configured such that both channel IDs corresponding to the BS-ID and channel IDs corresponding to the co-located BS-ID are stated in that record as the channel IDs. If configured in this way, information regarding the base station BS3 can be aggregated into a single record.

[2.2. Process Examples in Second Embodiment]

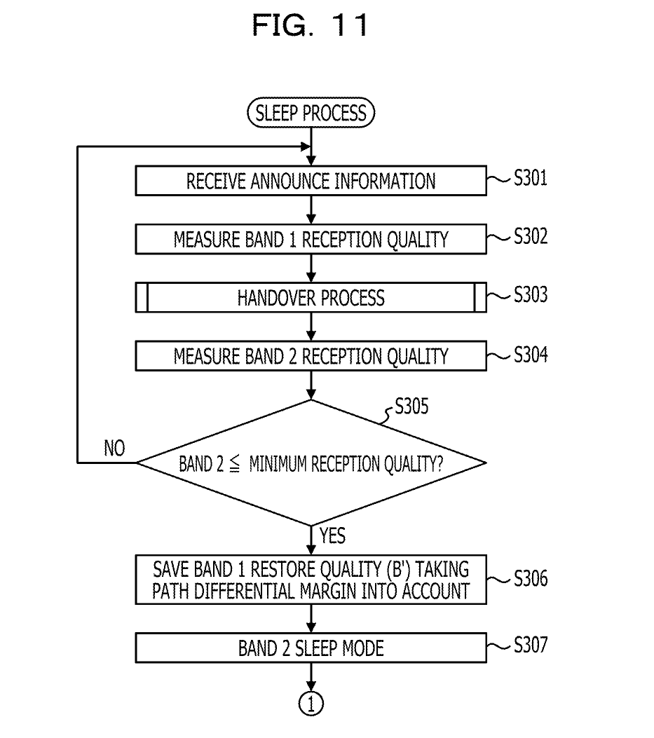

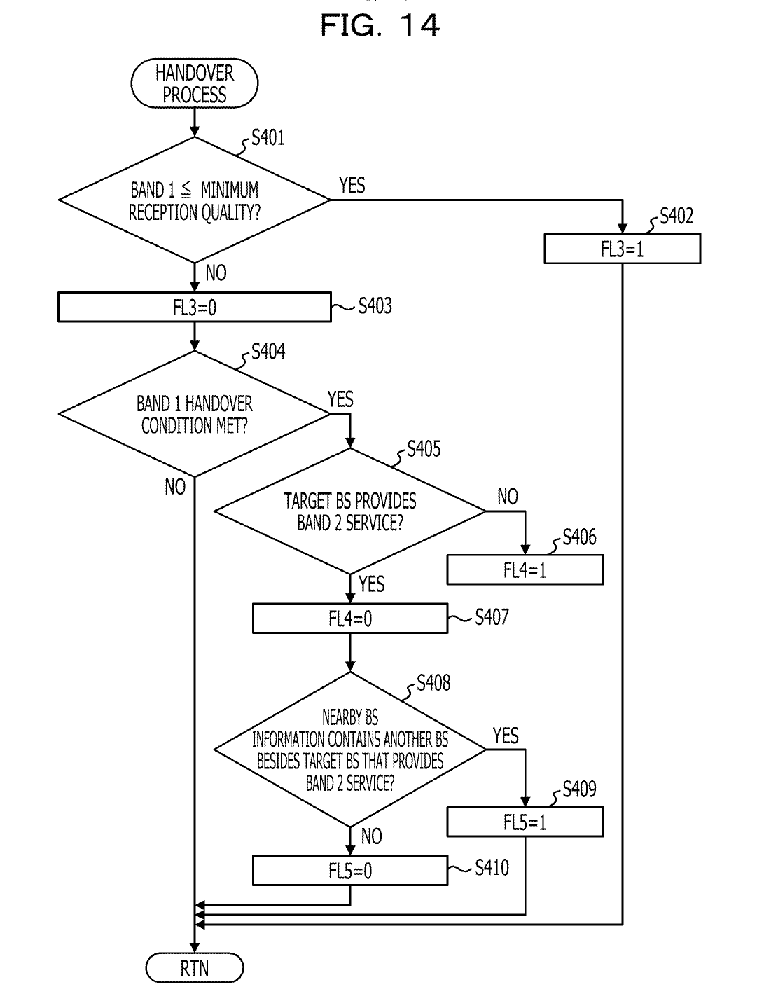

FIGS. 11 to 13 are flowcharts illustrating an exemplary sleep control process executed by a mobile station 100 in the second embodiment. FIG. 14 is a flowchart illustrating an example of the handover process illustrated in FIG. 11 (step S303). The signal processor 105 realizes the processing illustrated by the flowcharts described below by functioning as any of the modulator/demodulator 15, reception quality measuring section 16, controller 17, restore quality storage 18, restore determining section 19, and control information extractor 20 illustrated in FIG. 4.

In step S301 of FIG. 11, the mobile station 100 receives announce information from the serving base station. At this point, nearby base station information (see FIG. 10) contained in the announce information obtained by the modulator/demodulator 15 is extracted by the control information extractor 20 and passed to the controller 17. The nearby base station information is stored in a given storage area of the signal processing work memory 106.

In step S302, the signal processor 105 measures the Band 1 reception quality (S302), and subsequently conducts a handover process (S303). In the handover process, processing is executed according to steps S401 to S410 as illustrated in FIG. 14.

In FIG. 14, the signal processor 105 of the mobile station 100 determines whether or not the Band 1 reception quality measured prior to starting the handover process is less than or equal to a minimum reception quality (S401). In the case where the Band 1 reception quality is less than or equal to the minimum reception quality (S401, Yes), the signal processor 105 takes a flag FL3 from among sleep control flags FL3, FL4, and FL5 stored in advance in the signal processing work memory 106, sets the value of the flag FL3 to “1” (S402), and ends the handover process.

In contrast, in the case where the Band 1 reception quality exceeds the minimum reception quality (S401, No), the signal processor 105 sets the value of the flag FL3 to “0” (S403) and proceeds to step S404. Herein, the value of the flag FL3 indicates whether or not the mobile station 100 is at a position where Band 1 is available, wherein FL3=1 means that Band 1 is unavailable, and FL3=0 means that Band 1 is available.

In step S404, the signal processor 105 determines whether or not a Band 1 handover condition has been met. The handover process is terminated in the case where the handover condition has not been met (S404, No). Conversely, the process proceeds to step S405 in the case where the Band 1 handover condition has been met (S404, Yes).

In step S405, the signal processor 105 determines whether or not the post-handover base station (i.e., target base station) is providing Band 2 service. At this point, the signal processor 105 is able to determine whether or not the target base station covers or supports Band 2 by referencing the nearby base station information stored in the signal processing work memory 106.

In the case where the target base station does not cover or support Band 2 (S405, No), the signal processor 105 sets the value of the flag FL4 to “1” (S406) and proceeds to step S408. Conversely, in the case where the target base station does cover or support Band 2 (S405, Yes), the signal processor 105 sets the value of the flag FL4 to “0” (S406) and proceeds to step S408.

The value of the flag FL4 indicates whether or not the post-handover base station (i.e., target base station) supports Band 2, wherein FL4=1 means that Band 2 is not supported, and FL4=0 means that Band 2 is supported.

In step S408, it is determined whether or not the nearby base station information contains information regarding a base station besides the target base station that provides (i.e., supports) Band 2 service. In the case where the nearby base station information contains information regarding a base station that supports Band 2 (S408, Yes), the value of the flag FL5 is set to “1” (S409), and the handover process ends. Conversely, in the case where the nearby base station information does not contain information regarding a base station that supports Band 2 (S408, No), the value of the flag FL5 is set to “0” (S410), and the handover process ends.

The value of the flag FL5 indicates whether or not a base station supporting Band 2 exists near the post-handover base station (i.e., target base station) which does not support Band 2, wherein FL5=1 means that a base station supporting Band 2 does exist, and FL5=0 means that a base station supporting Band 2 does not exist.

In the handover process illustrated in FIG. 14, a handover is conducted if the process proceeds to step S405. Otherwise, a handover is not conducted. Once the handover process ends, the signal processor 105 of the mobile station 100 measures the Band 2 reception quality (S304) and determines whether or not the reception quality is less than or equal to a minimum restore quality a (S305).

If the Band 2 reception quality exceeds the minimum reception quality a (S305, No), the process returns to step S301. This means that Band 2 is available at the current position of the mobile station 100. In contrast, if the Band 2 reception quality is less than or equal to the minimum reception quality a (S305, Yes), then a restore quality that takes the path differential margin into account is generated from the Band 1 reception quality b at that time and saved (S306), and the Band 2 transceiver 104 is put into sleep mode (intermittent listening mode) (S307).

Subsequently, upon reaching a Band 2 reception quality measurement timing (S308), the signal processor 105 determines whether or not the flags FL3, FL4, and FL5 meet a flag condition stipulating FL3=0, FL4=1, and FL5=0 (Flag Condition 1) (S309). Flag Condition 1 represents a situation where although Band 1 is available, the target base station does not support Band 2, and there is no base station supporting Band 2 near the target base station.

The process proceeds to step S315 in the case where Flag Condition 1 is satisfied. In contrast, the process proceeds to step S310 in the case where Flag Condition 1 is not satisfied. Proceeding to step S310, the signal processor 105 of the mobile station 100 executes intermittent listening sleep control.

In other words, the signal processor 105 temporarily resumes receive processing by the Band 2 transceiver 104 (S310), and measures the Band 2 reception quality (S311). The signal processor 105 determines whether or not the Band 2 reception quality is greater than or equal to a given threshold (S312).

In the case where the reception quality is equal to or greater than the threshold (S312, Yes), intermittent listening mode is canceled and the Band 2 transceiver 104 is restored to operating mode (S313: End sleep). In contrast, intermittent listening mode is maintained (S314) in the case where the reception quality is less than the threshold (S312, No).

In step S315, the signal processor 105 measures the Band 1 reception quality and once again executes the handover process (see FIG. 14) (S316). Once the handover process ends, the signal processor 105 determines whether or not a flag condition stipulating FL3=0 and FL5=0 (Flag Condition 2) has been met as a result of the handover process (S317). Flag Condition 2 represents a situation where although Band 1 is available, a base station supporting Band 2 does not exist near the position of the mobile station 100.

If the flag condition has not been met in step S317 (S317, No), the process returns to step S308, and intermittent listening sleep control is conducted. Conversely, the process proceeds to step S318 in the case where the flag condition has been met (S317, Yes).

In step S318, the signal processor 105 determines whether or not the Band 1 reception quality is less than or equal to the restore quality b′. At this point, if the reception quality exceeds the restore quality b′ (S318, No), the process returns to step S308 and intermittent listening mode is maintained. In contrast, if the reception quality is less than or equal to the restore quality b′ (S318, Yes), the transceiver 104 is put into deep sleep mode, and the process proceeds to step S319.

In steps S319 and S320, the signal processor 105 measures the Band 1 reception quality and executes a handover process similarly to steps S302 and S303 or S315 and S316.

Once the handover process (S320) ends, the signal processor 105 checks for any changes in the flags FL3 to FL5 as a result of the handover process. Namely, it is determined whether or not a flag condition stipulating FL3=1 and FL5=1 (Flag Condition 3) has been met (step S321). Flag Condition 3 represents a situation where either Band 1 is unavailable or the mobile station 100 exists at a position with an independent base station supporting Band 2 nearby.

If Flag Condition 3 has been met (S321, Yes), the process returns to step S308 and the Band 2 transceiver 104 is switched from deep sleep mode to intermittent listening mode. Conversely, the process proceeds to step S322 in the case where Flag Condition 3 has not been met (S321, No).

In step S322, the signal processor 105 determines whether or not a flag condition stipulating FL4=0 (Flag Condition 4) has been met. Flag Condition 4 represents a situation where the target base station for Band 1 also supports Band 2. The process returns to step S319 in the case where Flag Condition 4 is not satisfied (S322, No). In contrast, the process proceeds to step S323 in the case where Flag Condition 4 is satisfied.

In step S323, processing similar to that of step S318 is conducted. In other words, it is determined whether or not the Band 1 reception quality is equal to or greater than the restore quality b′. At this point, if the reception quality is equal to or greater than the restore quality b′ (S323, Yes), the process returns to step S309 and the intermittent listening sleep control is conducted. Conversely, the process returns to step S319 if the reception quality is not equal to or greater than the restore quality b′ (S323, No).

[2.3. Advantages of Second Embodiment]

In the exemplary process described in the second embodiment (see FIGS. 11 to 14), a sleep control is applied to the transceiver 104 according to Process Example 1 of Control Example 2 in the first embodiment. Consequently, advantages similar to those of the first embodiment can be obtained with the second embodiment. Additionally, a sleep control using flags FL3 to FL5 is conducted.

Namely, if Flag Condition 1 is met in the determination in step S309, this means that although Band 1 is available to the mobile station 100, there is no base station supporting Band 2 nearby. In this case, the mobile station 100 conserves power by not measuring the Band 2 reception quality.

Also, if Flag Condition 2 is not met in the determination in step S317, this means that the mobile station 100 is currently positioned at a location where either Band 1 is unavailable or where there is an independent base station supporting Band 2 (such as BS6) nearby. In this case, the process returns to step S308 and a Band 2 intermittent listening sleep control (i.e., a periodic execution of Band 2 receive processing) is conducted. In so doing, it becomes possible to restore the transceiver 104 to operating mode when appropriate.

Also, if Flag Condition 3 is met in the determination in step S321, this means that the mobile station 100 is currently positioned at a location where either Band 1 is unavailable or where there is an independent base station supporting Band 2 (such as BS6) nearby. For this reason, the process returns to step S308 to apply the intermittent listening sleep control instead of deep sleep mode.

Also, it is configured such that if Flag Condition 4 is met in the determination in step S322, or in other words if the mobile station 100 is in the coverage area of a base station that provides both Band 1 and Band 2 service, the transceiver 104 is switched from deep sleep mode to intermittent listening mode if in addition the Band 1 reception quality reaches the restore quality b′ (S323).

Consider a mobile station 100 that has put its Band 2 transceiver 104 into sleep mode due to being in an area where Band 2 communication is unavailable, wherein the mobile station 100 subsequently conducts a Band 1 handover in order to switch to communication with an adjacent base station (target base station). With the second embodiment, it is possible for such a mobile station 100 to recognize from the nearby base station information whether or not the target base station has a Band 2 coverage area similar to the first base station (serving base station).

At this point, if the target base station does not support Band 2, a restore determination using the restore quality is not conducted by the restore determining section 19 while the mobile station 100 is inside the coverage area of that target base station. Thus, it is possible to avoid consuming power due to restoring the transceiver 104 to operating mode while in an area where Band 2 communication is unavailable.

Furthermore, in the case where the nearby base station information indicates that a base station supporting Band 2 only exists nearby, the transceiver 104 is switched to intermittent listening mode because of the possibility of initiating communication with such a base station by handover. In so doing, Band 2 communication can be resumed more quickly. The configurations of the foregoing embodiments may also be combined as appropriate.

According to the foregoing embodiments, it is possible to conduct a sleep control that enables a potential reduction in power consumption.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile terminal comprising:
a first transceiver which communicates a first signal in a first frequency band;
a second transceiver which communicates a second signal in a second frequency band;
a measuring section which measures a reception quality of the first signal received by the first transceiver, and a reception quality of the second signal received by the second transceiver;
a storage which stores one or more index values based on the reception quality of the first signal which is obtained when the reception quality of the second signal becomes less than or equal to a threshold value; and
a controller which puts the second transceiver into a sleep mode when the reception quality of the second signal becomes less than or equal to a threshold value, and cancels the sleep mode when a subsequently measured reception quality of a first signal becomes equal to or greater than the one or more index values.

2. The mobile terminal according to claim 1, wherein
the one or more index values are at least one of a first index value and a second index value, the first index value being the reception quality of the first signal which is obtained when the reception quality of the second signal becomes less than or equal to a threshold value, and the second index value being a value obtained by adjusting the first index value by an adjustment factor based on variations in the geographical propagation characteristics of the first signal.

3. The mobile terminal according to claim 2, wherein
when the reception quality of the first signal is between the first index value and the second index value, the controller puts the second transceiver into a first sleep mode in which operations are suspended except for intermittent receive processing for the second signal, and
when the reception quality of the first signal is less than the one or more index values, the controller puts the second transceiver into a second sleep mode in which operations including intermittent receive processing for the second signal are suspended.

4. The mobile terminal according to claim 1, wherein
when the reception quality of the first signal becomes less than or equal to a second threshold value while the second transceiver is in a sleep mode, the controller puts the second transceiver into a mode in which operations are suspended except for intermittent receive processing for the second signal.

5. The mobile terminal according to claim 1, wherein
when the second transceiver is in a sleep mode and a handover for the first frequency band is conducted during which nearby base station information received from the pre-handover base station indicates that the post-handover base station does not transmit the second signal, after executing the handover the controller avoids the sleep mode cancellation predicated on the reception quality of the first signal becoming equal to or greater than the one or more index values.

6. The mobile terminal according to claim 1, wherein
when the second transceiver is in a sleep mode and a handover for the first frequency band is conducted during which nearby base station information received from the pre-handover base station indicates that there is a base station that transmits the second signal nearby, after executing the handover the controller puts the second transceiver into a mode in which operations are suspended except for intermittent receive processing for the second signal.

7. A mobile communication control method, comprising:
measuring a reception quality of a first signal which is received in a first frequency band by a first transceiver of a mobile terminal, and measuring a reception quality of a second signals which is received in a second frequency band by a second transceiver of the mobile terminal;
storing one or more index values based on the reception quality of the first signal which is obtained when the reception quality of the second signal becomes less than or equal to a threshold value; and
putting the second transceiver into a sleep mode when the reception quality of the second signal becomes less than or equal to a threshold value, and canceling the sleep mode when the subsequently measured reception quality of the first signal becomes equal to or greater than the one or more index values.

8. The mobile communication control method according to claim 7, wherein
the one or more index values are at least one of a first index value and a second index value, the first index value being the reception quality of the first signal which is obtained when the reception quality of the second signal becomes less than or equal to a threshold value, and the second index value being a value obtained by adjusting the first index value by an adjustment factor based on variations in the geographical propagation characteristics of the first signal.

9. The mobile communication method according to claim 8, wherein
when the reception quality of the first signal is between the first index value and the second index value, the second transceiver is put into a first sleep mode in which operations are suspended except for intermittent receive processing for the second signal, and
when the reception quality of the first signal is less than the one or more index values, the second transceiver is put into a second sleep mode in which operations including intermittent receive processing for the second signal are suspended.

10. The mobile communication method according to claim 7, wherein
when the reception quality of the first signal becomes less than or equal to a second threshold value while the second transceiver is in a sleep mode, the second transceiver is put into a mode in which operations are suspended except for intermittent receive processing for the second signal.

11. The mobile communication method according to claim 7, wherein
when the second transceiver is in a sleep mode and a handover for the first frequency band is conducted during which nearby base station information received from the pre-handover base station indicates that the post-handover base station does not transmit the second signal, after executing the handover the sleep mode cancellation predicated on the reception quality of the first signal becoming equal to or greater than the one or more index values is avoided.

12. The mobile communication method according to claim 7, wherein
when the second transceiver is in a sleep mode and a handover for the first frequency band is conducted during which nearby base station information received from the pre-handover base station indicates that there is a base station that transmits the second signal nearby, after executing the handover the second transceiver is put into a mode in which operations are suspended except for intermittent receive processing for the second signal.

13. A mobile communication system comprising:
a mobile terminal, including
a first transceiver which communicates a first signal in a first frequency band,
a second transceiver which communicates a second signal in a second frequency band;
a measuring section which measures a reception quality of the first signal received by the first transceiver, and a reception quality of the second signal received by the second transceiver;
a storage which stores one or more index values based on the reception quality of the first signal which is obtained when the reception quality of the second signal becomes less than or equal to a threshold value; and
a controller which puts the second transceiver into a sleep mode when the reception quality of the second signal becomes less than or equal to a threshold value, and cancels the sleep mode when a subsequently measured reception quality of a first signal becomes equal to or greater than the one or more index values; and
a base station that communicates with the mobile terminal.
